(19) United States
(12) Patent Application Publication
(10) Pub. No.: US 2017/0323079 A1
(43) Pub. Date: Nov. 9, 2017

(54) METHOD FOR PROCESSING AN INPUT FOR CONTROLLING AN INFUSION OPERATION

(71) Applicant: Fresenius Vial SAS, Brézins (FR)

(72) Inventor: Frank Grube, Biol (FR)

(21) Appl. No.: 15/525,637

(22) PCT Filed: Oct. 27, 2015
(86) PCT No.: PCT/EP2015/074873

§ 371 Date: May 10, 2017

(30) Foreign Application Priority Data
Nov. 11, 2014 (EP) EP14306796.5

(51) Int. Cl. G06F 19/00; G06F 3/0488; G06F 3/0484; G06F 3/0482

(52) U.S. Cl. CPC G06F 19/3468; G06F 19/3406; G06F 3/0482; G06F 3/04845; G06F 3/0488

(57) ABSTRACT

A method for processing an input into a control device (3) for controlling the infusion operation of at least one infusion device (20) comprises the steps of: displaying a first view (V) on a touch-sensitive display device (30) of the control device (3), the first view (V) including a multiplicity of input elements (301-304); upon a first touch input by a user, determining a projection area (P) associated with the touch input on the first view (V); if the projection area (P) intersects with at least one input element (301-304) of the multiplicity of input elements (301-304), determining an intersection area (A1, A2) of the projection area (P) with the intersected at least one input element (301-304); and if the intersection area (A1, A2) with an intersected input element (301-304) is larger than a selection threshold (R1), identifying the associated input element (301-304) as selected. Herein, if the intersection area (A1, A2) with all of the at least one input element (301-304) does not exceed the selection threshold (R1), the intersected at least one input element (301-304) is displayed in an alternate view (V) if for the intersected at least one input element (301-304) a critical relevance criteria (C) is fulfilled. In this way a method is provided for processing an input for controlling an infusion operation which in a user-friendly fashion allows for the processing of touch inputs.

The invention relates to a method for processing an input into a control device for controlling the infusion operation of at least one infusion device according to the preamble of claim 1 and a control device for controlling the infusion operation of at least one infusion device.

Within a method of this kind a first view is displayed on a touch-sensitive display device of a control device, the first view including a multiplicity of input elements. Upon a first touch input by a user on the touch-sensitive display device, a projection area is determined associated with the touch input on the first view. If the projection area intersects with at least one input element of the multiplicity of input elements, an intersection of the projection area with the intersected at least one input element is determined. And if the intersection area with an intersected input element is larger than a selection threshold, the associated input element is identified as selected.

Nowadays, multiple infusion devices such as infusion pumps, for example volumetric pumps or syringe pumps, may be arranged in an organized fashion for example on a rack at the bedside of a patient in a health care environment, for example in an intensive care unit of a hospital. Each infusion device herein comprises an input device constituted for example by a touch-sensitive display allowing to input commands for controlling the operation of the associated infusion device. In addition, a central control device also referred to as “infusion manager” may be used for centrally controlling the operation of a multiplicity of infusion devices, for example to perform an infusion operation involving multiple infusion devices in a concerted fashion.

Via a local control device located on a particular infusion device or via a central control device for centrally controlling multiple infusion devices commands can be entered relating to the operation of one or multiple infusion devices. On touch-sensitive displays this generally is achieved by selecting an input element displayed on the touch-sensitive display, the input element corresponding to a particularly marked area on the touch-sensitive display.

However, because a user for making an input on a touch-sensitive display typically uses his finger, the touch input to some extend is inaccurate in that it generally is not possible for the user to confine the input to a well-defined point, but the touch input will cover an area of decent size on the touch-sensitive display device.

It therefore is necessary to determine for a touch input which input element is meant to be selected. Because a touched area associated with a touch input may be large, this task may not be easy and may even not be non-ambiguously possible, because a touched area may intersect with multiple input elements.

This, in relation to medical infusion devices, may additionally be critical if input elements relate to operations which have a critical relevance in that an erroneous, false command may have severe, potentially harmful consequences for a patient.

The determination of a selected input element of a touch-sensitive display device, hence, must carefully be performed in particular if the input element relates to a critical operation. If an input element for example relates to the starting or stopping of an infusion process, it is critical to select the input element correctly upon a touch input such that an infusion operation, which potentially may be vital for a patient, is not started or stopped erroneously by falsely detecting and selecting a corresponding input element.

There, hence, is a desire to improve the processing of input commands into control devices having a touch-sensitive display device.

Within conventional smart phones it nowadays is known that a portion of a display view is displayed in an enlarged fashion if a touch input by a user cannot unambiguously be associated with a particular input element. A method of this kind is for example known from US 2012/0144298 A. One difference with regard to controlling an infusion operation is, however, that input commands of a smart phone or another personal communication device generally are not very critical in that a wrong selection of an input element upon a touch input does not lead to severe consequences.

It is an object of the instant invention to provide a method for processing an input for controlling an infusion operation of at least one infusion device and to provide a control device for controlling an infusion operation which in a user-friendly fashion allow for the processing of touch inputs.

This object is achieved by a method according to the features of claim 1.

Herein, in addition to the steps stated at the beginning, it is provided that, if the intersection area with all of the at least one input element does not exceed the selected threshold, the intersected at least one input element is displayed in an alternate view if for the intersected at least one input element a critical relevance criteria is fulfilled.

Accordingly, it first is determined if the intersection area of the projection area with one or multiple input elements is larger than a predetermined selection threshold. If this is the case, the associated input element is identified as selected, and a control command associated with the input element is issued.

If this is not the case, hence if the intersection area with all input elements with which the projection area intersects does not exceed the predetermined selection threshold, those input elements which intersect with the projection area are displayed in an alternate view. This however only takes place if and only if an additional relevance criteria is fulfilled for at least one of the input elements which have been intersected by the projection area. If this is not the case, no alternate view is displayed, and no selection of an input element takes place, but another user input is awaited.

In one embodiment, the critical relevance criteria may simply be the check of a relevance tag assigned to an input element and having the Boolean values “true” or “false”. It hence may be checked whether an input element is regarded as having a critical relevance or not by checking whether its relevance tag has the value “true” or “false”. If it has a critical relevance and its tag accordingly has the tag value “true”, an alternate view is displayed if the projection area intersects the input element.

In another embodiment, the intersected at least one input element is displayed in an alternate view if and only if at least one of the input elements with which the projection area intersects has an assigned critical relevance level above a predetermined relevance threshold. If this is not the case, no alternate view is displayed, and no selection of an input element takes place, but another user input is awaited.

Generally, each input element may be assigned a different critical relevance level. The critical relevance level relates to a relevance of the operation that is performed upon selecting the input element.

If for example an input element relates to the starting or stopping of an infusion operation, the relevance of the input element may be high because upon selecting of the input element an infusion operation may be started or stopped, which potentially may be highly critical for a patient. If however an input element for example relates to the display of information or relates to selecting an infusion device for entering a further command with relation to that infusion device, the critical relevance level of that input element may be lower, because the selection of the input element does not have immediately critical consequences.

In another, third embodiment, a characteristic relevance value may be determined by multiplying an assigned critical relevance level of an input element with the intersection area of that input element. If that characteristic relevance value is above a threshold, the critical relevance criteria is fulfilled and an alternate view is displayed. The relevance criteria hence also takes the size of the intersection area into account, assuming that an input element with a small intersection area was less likely meant to be touched and hence not necessarily requires the displaying of an alternate view.

In any case, if a touch input cannot be associated in an unambiguous way to an input element, this does not necessarily have the consequence that an alternate view is displayed for allowing a disambiguation between different input elements. Rather, an alternate view is only displayed if at least one input element which intersects with the coverage area of a touch input has a certain critical relevance and hence fulfils a relevance criteria. The alternate view, hence, is displayed only if a further condition is fulfilled.

The alternate view serves to allow a user to disambiguate between different input elements to allow for a unique, unambiguous selection of an input element.

Within the alternate view, for example a portion of the original, first view may be displayed, the portion comprising only those input elements which have an intersection area with the projection area of the touch input. Within the portion the input elements may be displayed in an enlarged fashion such that a user can easily and unambiguously touch an input element and, in this way, select the input element which is desired.

Generally, in the alternate view those input elements which intersect with the projection area of the touch input by the user may be displayed in an enlarged way. The alternate view, hence, may be a zoomed-in view of the original, first view. In addition or alternatively, within the alternate view the input elements may be displayed in an animated fashion, for example by marking those input elements which intersect with the touch input by the user using color or a particular visual appearance.

If within the alternate view a user selects one of the displayed input elements, this selection is regarded as a disambiguation signal in that it is interpreted as a unique choice of the input element. If the input of the user in the alternate view however is ambiguous in that it intersects with multiple input elements, a further input by the user may be awaited or particularly requested until an unambiguous selection of an input element has taken place. Possibly, the user may be asked to confirm his selection.

If however no touch input is detected in the alternate view for a predetermined time interval, this may be interpreted as no selection at all such that no command is entered and processed.

Upon selection of an input element in the alternate view or upon lapse of the time interval, the display device may return to the original first view. A user may hence input further commands by selecting further input elements.

The projection area which is determined according to a touch input by the user in general may have any shape or size. For example, the projection area may be that area which actually is touched for example by a finger of a user.

However, it also is possible that upon a touch input a generalized projection area is derived. For example, from a touch input a touch point may be derived according to the center of mass of the actually touched area, and around the touch point a generalized projection area may be generated. The generalized projection area may have any predetermined shape and may, for example, be rectangular or circular in shape. The size of the projection area may be pre-configurable such that any touch input has a projection area of pre-configured size.

If the generalized projection area derived from the touch input has a circular shape, it may have a predetermined diameter according to a pre-configuration setting of the control device. The diameter may, for example, lie in the range between 2 mm and 10 mm, for example at 5 mm.

Input elements having a high critical relevance may for example be a start button and/or a stop button for starting respectively stopping an infusion operation of one or multiple infusion devices such as infusion pumps. Such input elements may for example have a relevance tag having the Boolean value “true”, or they may be assigned a high critical relevance level exceeding a predetermined relevance threshold.

The object is also achieved by means of a control device for controlling the infusion operation of at least one infusion device, the control device comprising a touch-sensitive display device. The control device may be part of an infusion device, or it may be a central control device for controlling the infusion operation of multiple infusion devices to which the control device is connected. The touch-sensitive display device herein is configured to display a first view including a multiplicity of input elements and, upon a first touch input by a user, to determine a projection area associated with the touch input on the first view. If the projection area intersects with at least one input element of the multiplicity of input elements, the touch-sensitive display device determines an intersection area of the projection area with the intersected at least one input element and, if the intersection area with an intersected input element is larger than a selection threshold, identifies the associated input element as selected. Herein, the touch-sensitive display device is further constituted to, if the intersection area with all of the at least one input element does not exceed the selection threshold, display the intersected at least one input element in an alternate view if for the intersected at least one input element a critical relevance criteria is fulfilled.

The advantages and advantageous embodiments described above for the method equally apply also to the control device such that it shall be referred to the above.

The idea underlying the invention shall subsequently be described in more detail with regard to the embodiments shown in the figures. Herein:

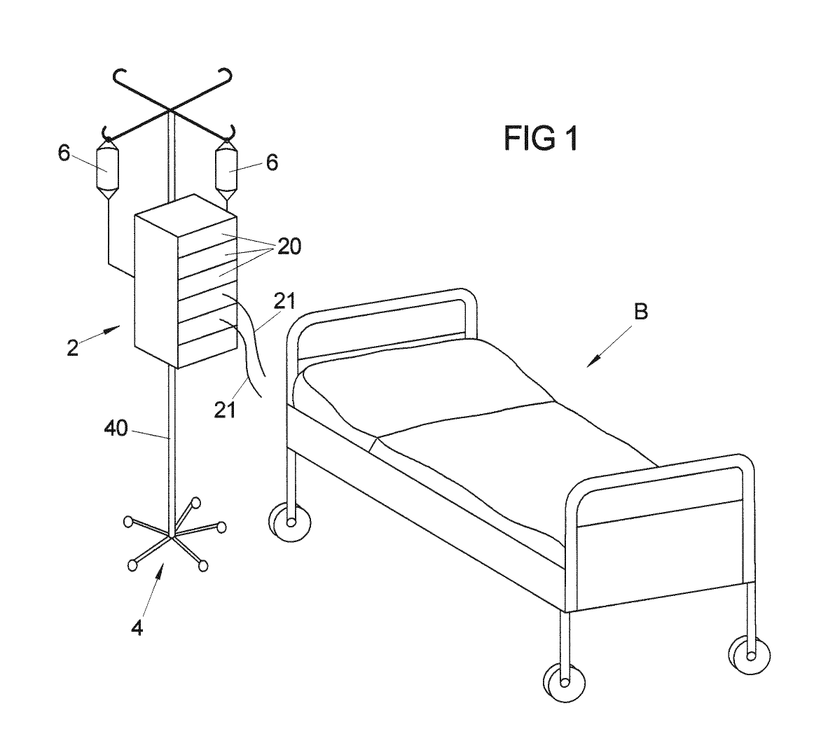

FIG. 1 shows a schematic view of a typical scenario in which infusion devices are arranged at the bedside of a patient within a hospital environment;

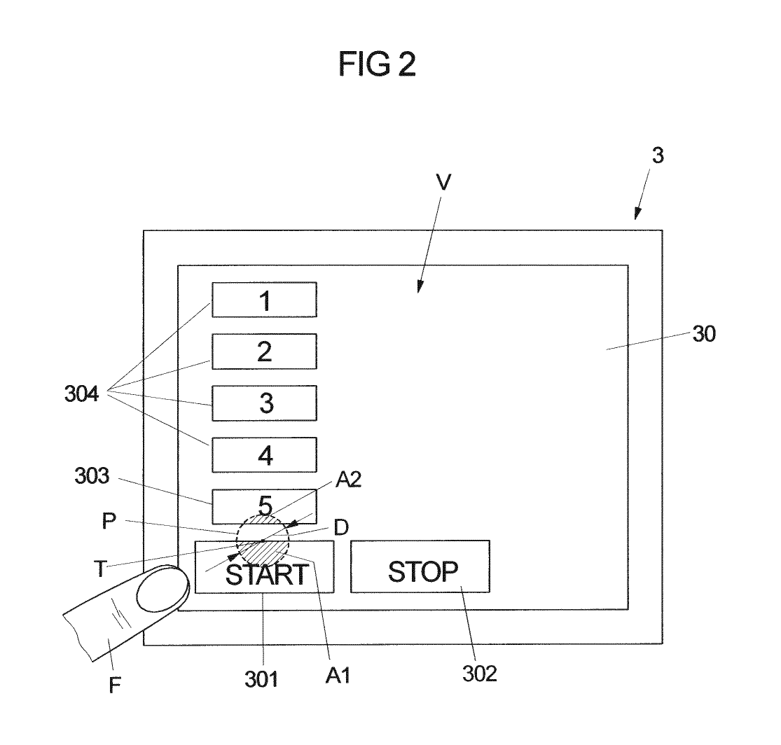

FIG. 2 shows a control device having a touch-sensitive display device for displaying a view for selecting input elements;

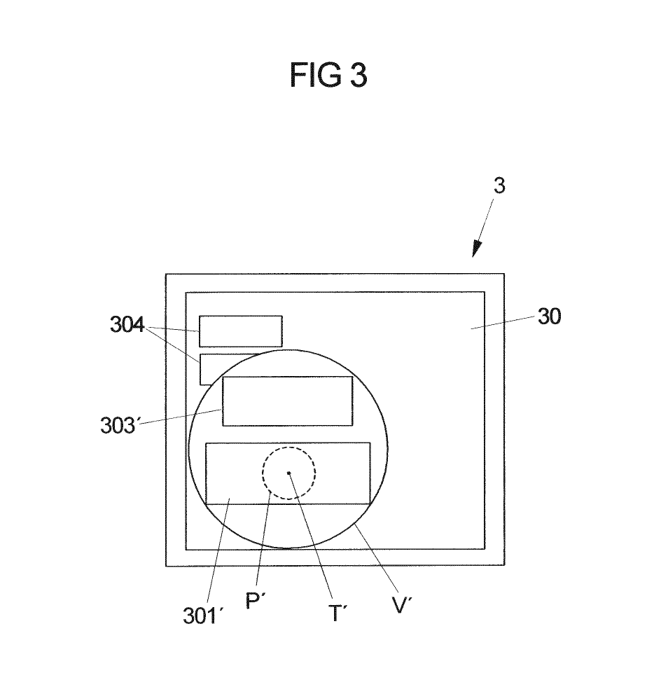

FIG. 3 shows an alternate view of the display device; and

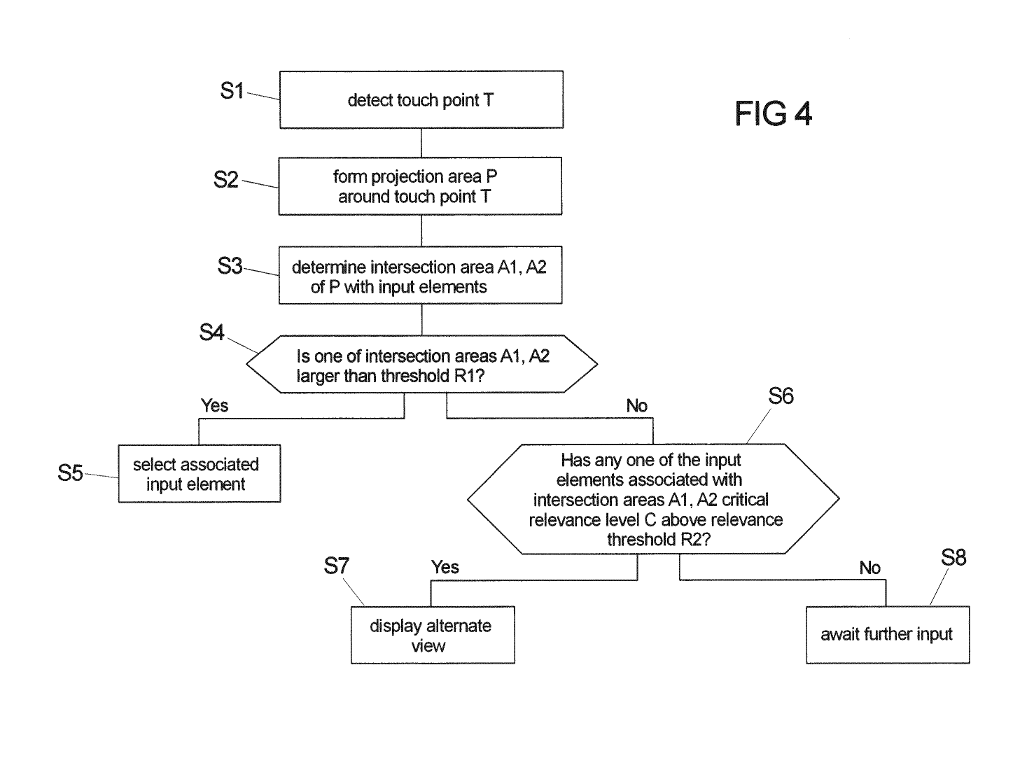

FIG. 4 shows a flow diagram of a method for processing an input into a control device.

FIG. 1 shows in a schematic drawing a scenario as it typically can be found in a hospital environment, for example an intensive care unit of a hospital. Next to the bed B of a patient a number of medical devices 20 constituted for example as infusion pumps such as syringe pumps or volumetric pumps are located and connected to a patient via infusion lines 21. The medical devices 20 serve to administer a fluid such as a medication or nutrients for example contained in containers 6 via infusion lines 21 to the patient, the infusion lines 21 (especially in the environment of an intensive care unit of a hospital) possibly being vital to the patient such that they under all conditions must remain connected to the patient to ensure the required administration of medication, nutrients or the like.

Typically, the medical devices 20 constituted as infusion pumps are organized on a rack 2 to form a vertical stack of medical devices 20 which is fixed for example to a stand 4. The stand 4 may comprise wheels such that the stand 4 at least to some extend is movable with respect to the patient's bed B or together with the patient's bed B. The stand 4 may comprise a pole 40 to which the rack 2 for carrying the medical devices 20 is attached and comprises, at its top end, fastening means in the shape of hooks to fasten a number of containers 6 containing medication or nutrients or other fluids to be administered to the patient.

The rack 2 serves to arrange the medical devices 20 in an organized fashion at the bedside of the patient. The rack 2 herein provides a power supply for the medical devices 20, ensures a secure and reliable fixation of the medical devices 20, and provides a communication of the medical devices 2 among each other and with an external communication network and with external periphery devices such as a nurse call, a printer, a computer, a monitor or the like.

Conventionally, the medical devices 20 can be fixed to the rack 2 and for this are mechanically and electrically connected to the rack 2 such that via the rack 2 each medical device 20 can be supplied with power and may communicate with other medical devices 20 and with external devices and/or an external communication network. The rack 2 hence serves as a communication spine providing a communication facility and an electric power supply and embedding the medical devices 20 into a hospital environment including a hospital communication network and a hospital management system.

FIG. 2 shows a separate view of an embodiment of a control device 3 which, as a central control device 3, may be constituted to control the infusion operation of multiple infusion devices 20, for example located on a rack 2 as shown in FIG. 1. The control device 3 has a touch-sensitive display device 30 which is constituted to display in one or multiple views V input elements 301-304 which a user may select to enter input commands into the control device 3.

The input elements 301-304 correspond to areas of a view V of the touch-sensitive display device 30 and are marked for example by bounding boxes and/or a particular color such that the user may differentiate the input elements 301-304 from each other and from other areas of the view V not relating to a user input.

For example, a first input element 301 may be a start button allowing a user to start an infusion operation. A second input element 302 may be a stop button allowing a user to stop an infusion operation. Further input elements 303, 304 may be selection buttons allowing a user to select one infusion device 20 out of the multiplicity of infusion devices 20 arranged on the rack 2 for inputting a control command with regard to that infusion device 20 or for displaying information in relation to the operation of the infusion device 20. Further input elements may be present relating to other commands and allowing for example to configure settings of the control device, for displaying information or the like.

A user generally may use his finger F to touch an input element 301-304 to select the input element 301-304 in order to enter the command associated with the input element 301-304 into the control device 3. For this it is potentially critical that, upon a touch input by a user, the device control software causes the correct input element 301-304 to be selected, because an erroneous selection of an input element 301-304 (which the user did not intend to select) may lead to a false start or stop of an infusion operation or another non-intended action which may have potentially severe consequences for a patient.

The processing of a touch input hence, in one embodiment, takes place in the following way. The general procedure is also illustrated in the flow diagram of FIG. 4.

Upon a touch of a finger F of a user on the view V of the touch-sensitive display device 30, as for example shown in FIG. 2, a projection area P is determined. The projection area P may be determined according to the actual coverage area of the touch input, i.e., the area which actually has been touched by the finger F of the user. Alternatively, the projection area P may also be determined in a generalized fashion in that from the touch input a touch point T is determined, for example according to the center of mass of the touch input, and around the touch point T the projection area P is spanned using a predetermined shape and size (steps S1 and S2 in FIG. 4).

In the example shown in FIG. 2, the projection area P has a circular shape having a predetermined diameter D.

If the projection area P is determined in a generalized fashion to have a predetermined shape and size, the shape and size may be configurable by adjusting the settings of the control device 3. For example, the diameter D of a circular projection area P may be set to an appropriate value, for example ranging between 2 mm and 10 mm, for example 5 mm.

Once the projection area P is determined, it further is determined if the projection area P intersects with one or multiple input elements 301-304. If this is the case, the intersection areas A1, A2 of the projection area P with the corresponding input elements 301-304 are determined (step 103 in FIG. 4).

In this regard it is to be noted that it is possible that a projection area P intersects with none, with one, with two or even more than two input elements 301-304 (i.e., N with N>2), forming a corresponding number of intersection areas A1, A2, . . . AN.

In the shown example, the projection area P relating to a touch input intersects with the input element 301 (i.e., the start button) and the input element 303 (i.e., a selection element for selecting an infusion device 20). Hence, two intersection areas A1, A2 exist indicating the intersecting areas of the projection area P with the input elements 301, 303.

It now is determined whether one of the intersection areas A1, A2 is larger than a predetermined selection threshold R1 (step S4 in FIG. 4). If this is the case, it is assumed that the touch input shall unambiguously relate to the input element 301, 303 for which this is the case, and the corresponding input element 301, 303 is selected (step S5 in FIG. 4).

If however this is not the case, it further is for example determined whether any of the input elements 301, 303 associated with the intersection areas A1, A2 have a critical relevance level C above a predetermined relevance threshold R2 (step S6 in FIG. 4). If and only if this is the case, a portion of the view V including the intersecting input elements 301, 303 is displayed in an alternate view V′ as shown in FIG. 3 (step 107 in FIG. 4). If this is not the case, a further user input may be awaited without displaying an alternate view V′, hence disregarding the previous ambiguous input (step S8 in FIG. 4).

For example, the critical relevance level C of the input element 301 may be set to 0.9, the critical relevance level C of the input element 302 may be set to 0.8, and the critical relevance level C of the input elements 303, 304 may be set to 0.2. If the relevance threshold R2 is configured to lie at 0.5, at least the critical relevance level C of input element 301 intersected by the projection area P lies above the relevance threshold R2, such that for the input element 301 a relevance criteria (i.e. the exceeding of the relevance threshold R2) is fulfilled.

In this regard it is to be noted that also other relevance criteria may exist and may be used. For example the input elements 301-304 may be assigned relevance tags having Boolean values “true” or “false”. In step S6 in that case it simply is checked whether for an intersected input element 301, 303 the relevance tag has the value “true”, and only if this is the case an alternate view V′ is displayed.

Within the alternate view V′ the potential candidate input elements 301, 303 are displayed for example in an enlarged fashion as enlarged input elements 301′, 303′. Alternatively or additionally, in the alternate view V′ the candidate input elements 301, 303 may be displayed in an animated fashion, for example by displaying the input elements 301, 303 which intersect with the projection area P using an animation such as a particular color marking or a visual effect such as a blinking effect or the like.

Once the alternate view V′ is displayed, a further user input is awaited. If the user touches the alternate view V′, the touch input is considered to be a disambiguation signal such that the input element 301, 303 which is touched by the user is selected. In the example of FIG. 3 the further touch input has a projection area P′ around a touch point T′ unambiguously corresponding to the input element 301′, i.e., the start button 301 as shown in the view V according to FIG. 2.

Accordingly, the action associated with the selected input element 301, 301′ is carried out.

If in the alternate view V′ the further user input is ambiguous, the user may be requested to repeat his input until a non-ambiguous input is obtained.

Upon a disambiguated selection of an input element 301′, the display device 30 may return to its original, first view V, as shown in FIG. 2, or a completely different V may be displayed.

If in the alternate view V′ no user input is detected, the display device 30 beneficially returns to the original, first view V after lapse of a predetermined time interval. In that case, no input element 301-304 is selected, and the display device 30 awaits a further user input.

The displaying of the alternate view V′ hence takes place only if two conditions are fulfilled. Namely, the intersecting intersection areas A1, A2 of a projection area P of a touch input are smaller than a selection threshold R1, and in addition a relevance criteria is fulfilled, i.e., in the described embodiment at least one input element 301-304 intersecting with the projection area P has a critical relevance level C above a predetermined relevance threshold R2. By taking the latter into account, it is made sure that an alternate view V′ is displayed only for those elements 301-304 which have some sort of critical relevance. For non-critical input elements 301-304 no alternate view V′ is displayed, hence making the appearance to the user more appealing and in particular avoiding the repeated displaying of alternate views V′ even for non-critical input elements 301-304.

Each input element 301-304, in the described embodiment, may be assigned a particular critical relevance level C depending on the action associated with the selection of the input element 301-304. For example, the starting or the stopping of an infusion operation has rather severe consequences because an infusion operation potentially is vital to a patient and hence must not be started or stopped erroneously. In contrast, the displaying of information or the like may have a small critical relevance because upon selection of a corresponding input element no severe consequences occur.

The assignment of the critical relevance values C to the different input elements 301-304 may be pre-set and may be not adjustable by a user. Alternatively, it also is possible that a user is able to adjust the critical relevance levels such that he can freely configure the control device 3 as desired.

In addition or alternatively, the relevance threshold R2 may be user adjustable such that a user, by adjusting the relevance threshold R2, may configure for which input elements 301-304 an alternate view V′ is potentially displayed or not.

The idea underlying the invention is not limited to the embodiments described above, but may be implemented also in an entirely different fashion.

For example, a control device of the kind described above may also be integral to an infusion device such as an infusion pump. The control device not necessarily is constituted as a central control device for controlling the infusion operation of multiple infusion devices.

Also, on the display device of the control device an entirely different input element than the one described above may be present.

### LIST OF REFERENCE NUMERALS

1 System
2 Organization device
20 Medical device
21 Infusion lines
3 Control device
30 Touch-sensitive display device
301, 301′ Input element (start button)
302 Input element (stop button)
303 Input element (selection button)
304 Input elements
4 Stand
40 Pole
6 Infusion bags
A1, A2 Intersection area
B Patient's bed
C Critical relevance level
D Diameter
F Finger
P, P′ Projection area
R1 Selection threshold
R2 Relevance threshold
S1-S8 Steps
T, T′ Touch point
V View
V′ Alternate view

1. A method for processing an input into a control device for controlling the infusion operation of at least one infusion device, comprising the steps of:
displaying a first view on a touch-sensitive display device of the control device, the first view including a multiplicity of input elements,
upon a first touch input by a user, determining a projection area associated with the touch input on the first view,
if the projection area intersects with at least one input element of the multiplicity of input elements, determining an intersection area of the projection area with the intersected at least one input element, and
if the intersection area with an intersected input element is larger than a selection threshold, identifying the associated input element as selected,
wherein, if the intersection area with all of the at least one input element does not exceed the selection threshold, the intersected at least one input element is displayed in an alternate view if for the intersected at least one input element a critical relevance criteria is fulfilled.

2. The method according to claim 1, wherein the intersected at least one input element is displayed in an alternate view if and only if an input element of the intersected at least one input element has an assigned critical relevance level above a relevance threshold.

3. The method according to claim 2, wherein each input element is assigned a critical relevance level.

4. The method according to claim 1, wherein the alternate view displays a portion of the first view.

5. The method according to claim 1, wherein the alternate view displays the intersected at least one input element in an enlarged fashion.

6. The method according to one of the preceding claim 1, wherein the alternate view displays the intersected at least one input element with a predetermined visual animation.

7. The method according to claim 1, further comprising interpreting a second touch input of a user on the alternate view as a disambiguation signal for selecting one of the selected at least one input elements displayed in the alternate view.

8. The method according to claim 1, further comprising not interpreting any input element as selected if no further touch input is detected for the alternate view within a predetermined time interval.

9. The method according to claim 7, further comprising returning to the first view.

10. The method according to claim 1, wherein the projection area is formed around a detected touch point associated with the first touch input.

11. The method according to claim 1, wherein the projection area has a predetermined size.

12. The method according to claim 1, wherein the projection area has a circular shape with a predetermined diameter.

13. The method according to claim 1, wherein the projection area is configurable in form and/or size.

14. The method according to claim 1, wherein an input element for starting an infusion operation and/or an input element for stopping an infusion operation is assigned a critical relevance level larger than a critical relevance level of other input elements.

15. A control device for controlling the infusion operation of at least one infusion device, comprising a touch-sensitive display device configured to:
display a first view including a multiplicity of input elements,
upon a first touch input by a user, determine a projection area associated with the touch input on the first view,
if the projection area intersects with at least one input element of the multiplicity of input elements, determine an intersection area of the projection area with the intersected at least one input element, and
if the intersection area with an intersected input element is larger than a selection threshold, identify the associated input element as selected,
wherein the touch-sensitive display device is further constituted to, if the intersection area with all of the at least one input element does not exceed the selection threshold, display the intersected at least one input element in an alternate view if for the intersected at least one input element a critical relevance criteria is fulfilled.
